(19) United States
(12) Patent Application Publication
(10) Pub. No.: US 2007/0190889 A1
(43) Pub. Date: Aug. 16, 2007

(54) Mask and method of manufacturing the same

(75) Inventors: Joo-Hyeon Lee, Yongin-si (KR); Chang-Mo Park, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/707,397

(22) Filed: Feb. 15, 2007

(30) Foreign Application Priority Data
Feb. 16, 2006 (KR) 10-2006-0015000

(51) Int. Cl. H01J 9/12

(52) U.S. Cl. 445/47

(57) ABSTRACT

A mask that facilitates OLED processing and is capable of being made cost-effectively is presented. The mask includes a mask frame, a connection frame fastened to the mask frame, a mask plate welded to the connection frame, and a plurality of fastening members that fasten the connection frame to the mask frame. The connection frame, which is capable of being welded to the mask plate, is interposed between the mask plate and the mask frame to create a tension in the mask plate. Thus, it is possible to manufacture a shadow mask that does not sag. The mask frame may be formed with a light metal such as aluminum.

### CROSS-REFERENCE TO RELATED APPLICATION

This application claims priority to and the benefit of Korean Patent Application No. 10-2006-0015000 filed in the Korean Intellectual Property Office on Feb. 16, 2006, the entire content of which is incorporated herein by reference.

### BACKGROUND OF THE INVENTION

(a) Field of the Invention

The present invention relates to a mask and a method of manufacturing the same.

(b) Description of the Related Art

An OLED (organic light emitting display) includes two electrodes and a light emission layer interposed between the electrodes. An electron from one electrode combines with a hole from the other electrode in the light emission layer to form an exciton. The exciton emits light while emitting energy.

The OLED is a self-light emitting type device that does not require a separate light source. Not needing a separate light source makes the OLED advantageous from the perspective of power consumption and enables the device to operate with an excellent response speed, viewing angle, and contrast ratio.

The two electrodes are made of a transparent conductive material such as ITO or IZO, and a pattern is formed on each electrode by means of a photolithography process. However, since the light emission layer is very vulnerable to moisture, forming the pattern using the photolithography process is tricky. Hence, the pattern is often formed using a shadow mask.

However, when a large area OLED is formed, sagging of a mask plate of the shadow mask causes difficulty in forming a fine pattern. It is desirable to prevent the sagging of the mask plate.

### SUMMARY OF THE INVENTION

The present invention provides a mask that is capable of being used to manufacture a large area OLED and a method of manufacturing the same.

In one aspect, the present invention is a mask that includes a mask frame, a connection frame fastened to the mask frame, a mask plate welded to the connection frame, and a plurality of fastening members that fasten the connection frame to the mask frame.

The mask frame may be made of a metal having a specific gravity of 8 or less or a metal having a specific gravity of 2 to 5.

The mask frame may be made of any aluminum or titanium.

The connection frame may be made of the same material as the mask plate and be made of any stainless steel or nickel alloy steel.

The fastening members may each include a male thread and a female thread formed in the connection frame and the mask frame.

In another aspect, the present invention provides a method of manufacturing a mask. The method includes providing a mask frame, fastening a connection frame to the mask frame using fastening members, and welding the mask plate to the connection frame.

The mask frame may be made of a metal having a specific gravity of 8 or less or a metal having a specific gravity of 2 to 5.

The connection frame may be made of the same material as the mask plate and be made of stainless steel or nickel alloy steel.

### BRIEF DESCRIPTION OF THE DRAWINGS

FIG. 1 is a top plan view of a shadow mask according to an exemplary embodiment of the present invention.

FIG. 2 is a cross-sectional view of the shadow mask according to an exemplary embodiment of the present invention.

FIG. 3 is an enlarged view of the region A in FIG. 2.

FIGS. 4 and 5 are views sequentially showing the manufacture of the shadow mask according to an exemplary embodiment of the present invention.

FIG. 6 is a view showing the formation of a thin film pattern of an OLED using the shadow mask according to an exemplary embodiment of the present invention.

### DETAILED DESCRIPTION OF THE EMBODIMENTS

The present invention now will be described more fully hereinafter with reference to the accompanying drawings, in which preferred embodiments of the invention are shown. As those skilled in the art would realize, the described embodiments may be modified in various different ways, all without departing from the spirit or scope of the present invention.

A detailed description will be given of a mask and a method of manufacturing the same according to an exemplary embodiment of the present invention with reference to the accompanying drawings.

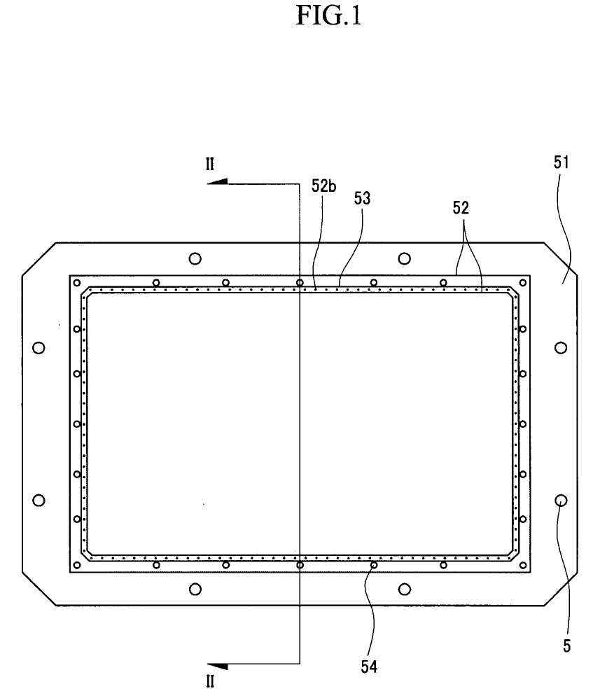

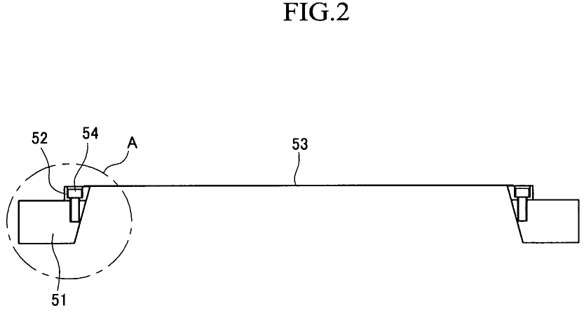

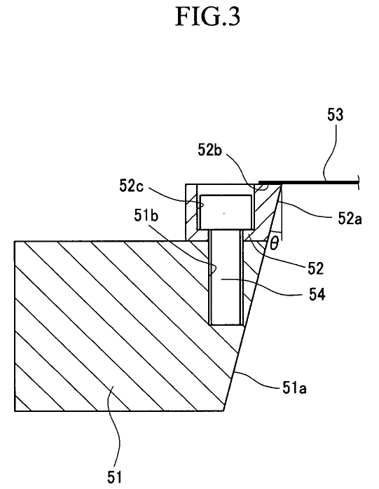

FIG. 1 is a top plan view of a shadow mask according to the exemplary embodiment of the present invention, FIG. 2 is a cross-sectional view taken along the line II-II of FIG. 1, and FIG. 3 is an enlarged view of the region A in FIG. 2.

As shown in FIGS. 1 to 3, the shadow mask according to the exemplary embodiment of the present invention includes a mask frame 51 shaped like a picture frame, a connection frame 52 fastened to a portion of the mask frame 51, and a mask plate 53 welded to a portion of the connection frame 52.

The shadow mask is used to form and pattern a material layer such as a light emission layer or an electrode on a substrate during the manufacture of the OLED. A typical shadow mask is a fine shadow mask where patterns are formed to correspond to pixels, and the shadow mask is exemplified by the fine shadow mask in the exemplary embodiment of the present invention. However, the present invention may also be applied to an open mask that is used to simultaneously form multiple thin films on display areas when all of the display areas where the pixels are collected are opened.

The mask frame 51 has a rectangular picture frame shape, and a support member 5 is formed in the mask frame 51 to maintain the mask frame 51 at a predetermined height from the surface of the land. FIG. 1 shows support grooves 5 used as the support member, and a plurality of support grooves 5 are formed at predetermined intervals.

In the shadow mask according to the exemplary embodiment of the present invention, a thin film is formed by growing downwardly from an upper part to a lower part. To achieve the formation, a thin film injection device 60 is provided under the shadow mask and a substrate 100 is provided on the shadow mask. Therefore, it is necessary to maintain the shadow mask at a predetermined height, and the support members 5 are formed on the mask frame 51 in order to achieve this.

It is preferable to form the mask frame 51 using a light metal. The shadow mask rotates and may be replaced during a thin film forming process to assure uniformity of a thin film. Since the mask frame 51 is the heaviest portion of the shadow mask for a large area OLED, the mask frame 51 being made of a light material effectively reduces the weight load of an equipment.

Therefore, the mask frame 51 is made of metal having a specific gravity of 8 or less. According to an exemplary embodiment, the mask frame 51 is made of metal having a specific gravity of 1 to 8. According to another embodiment, the mask frame 51 is made of metal having a specific gravity of 2 to 5. Exemplary materials constituting the mask frame 51 include aluminum (Al) and titanium (Ti), and the specific gravity of aluminum is 2.7 at 20° C.

In particular, if the mask frame 51 is formed with aluminum, the cost of material of the mask frame 51 is low and processing is easily conducted.

A fine pattern is formed on the mask plate 53 such that it corresponds to a desired thin film pattern, and it is preferable that the mask plate 53 be made of a metal having a low thermal expansion coefficient such as stainless steel or nickel alloy steel to prevent the fine pattern from deforming. The appropriate stainless steel is exemplified by SUS 420, and the appropriate nickel alloy steel is exemplified by Invar 36 which is an alloy including 63.5% iron and 36.5% nickel and which has a low thermal expansion coefficient.

The connection frame 52 has substantially the same shape as the mask frame 51, and is mounted on the mask frame 51. The mask frame 51 may be an integrated frame or a frame formed by assembling multiple pieces (e.g., four bars).

It is preferable that the connection frame 52 be made of the same material as the mask plate 53. If the mask plate 53 and the connection frame 52 are made of the same stainless steel or nickel alloy steel, it is possible to weld the mask plate and the connection frame to each other. The mask plate 53 is welded to a welded part 52b of the connection frame 52. The welded part 52b is formed on the connection frame 52.

The mask plate 53 and the connection frame 52 are welded to create a tension level that is sufficient to prevent sagging of the large mask plate 53 used to manufacture the large OLED.

In order to avoid difficulty in directly welding the mask plate 53 made of the stainless steel or the nickel alloy steel to the mask frame 51 made of aluminum, the connection frame 52 is interposed between the mask plate 53 and the mask frame 51 and welded to the mask plate 53.

Additionally, the connection frame 52 is fastened to the mask frame 51 using a fastening member. As shown in FIG. 3, the fastening member 30 includes a male thread 54, and female threads 52c and 51b formed in the connection frame 52 and the mask frame 51. The male thread 54 screws into the female threads 52c and 51b to fasten the connection frame 52 and the mask frame 51 to each other.

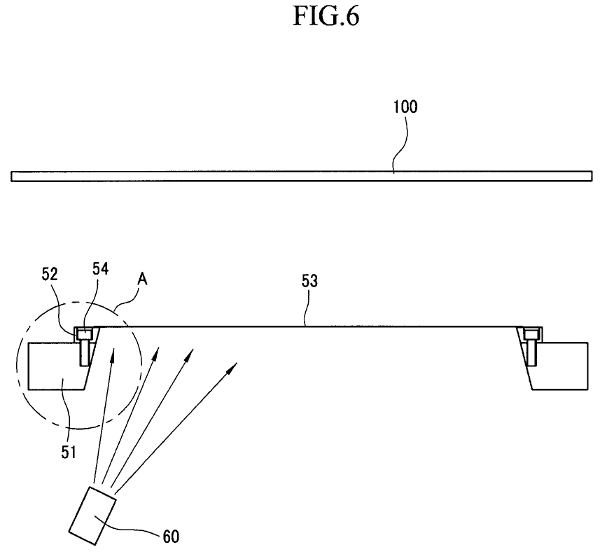

Meanwhile, it is preferable that inner surfaces 51a and 52a of the mask frame 51 and the connection frame 52 be inclined at a predetermined angle (θ). The reason for this is that, since the thin film injection device 60 (see FIG. 6) injects an organic vapor while inclined at a predetermined angle to correspond in position to the mask frame 51 so as to improve the uniformity of the thin film when a thin film pattern is formed on the substrate 100 (see FIG. 6), the inner surfaces 51a and 52a of the mask frame 51 and the connection frame 52 are inclined to prevent the injection of the organic vapor from being blocked (see FIG. 6).

A method of manufacturing the above-mentioned shadow mask according to an exemplary embodiment of the present invention will now be described in detail in reference to FIGS. 4, 5, and 2.

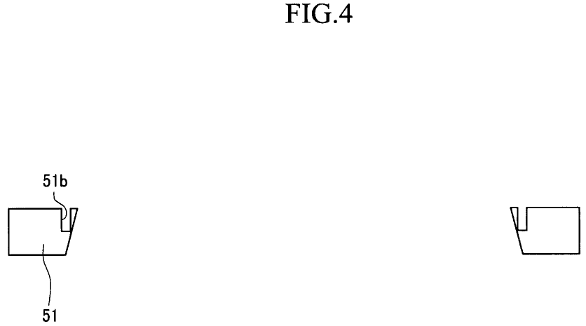

First, as shown in FIG. 4, the mask frame 51, which has the female thread 51b and is made of aluminum, is provided at a predetermined height from the surface of the land. The support members 5 are formed on the mask frame 51 to maintain the mask frame 51 at the predetermined height from the surface of the land.

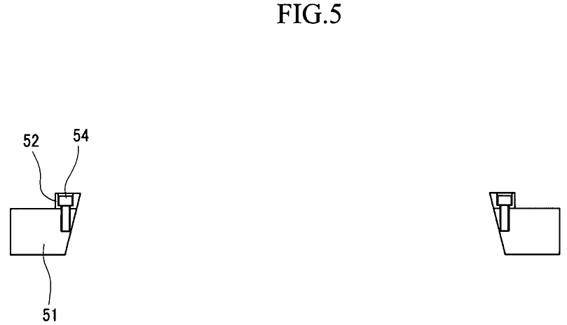

Next, as shown in FIG. 5, the connection frame 52, which has the female thread 52c (see FIG. 3) and is made of the stainless steel or the nickel alloy steel, is provided on the mask frame 51. Furthermore, the male thread 54 screws into the female threads 51b and 52c to fasten the mask frame 51 and the connection frame 52 to each other.

Next, as shown in FIG. 2, an edge of the mask plate 53 made of the stainless steel or the nickel alloy steel is welded to the welded part 52b of the connection frame 52.

In the mask and the method of manufacturing the same according to an embodiment of the present invention, the connection frame, which is capable of being welded to the mask plate, is interposed between the mask plate and the mask frame to attribute tension to the mask plate, thus making it is possible to manufacture the light shadow mask.

Furthermore, the mask frame is formed using a light metal such as aluminum. Thus, the cost of materials for the mask frame is low and processing is easily conducted.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A mask comprising:
a mask frame;
a connection frame fastened to the mask frame;
a mask plate welded to the connection frame; and
a plurality of fastening members that fasten the connection frame to the mask frame.

2. The mask of claim 1, wherein the mask frame is made of a metal having a specific gravity of 8 or less.

3. The mask of claim 1, wherein the mask frame is made of a metal having a specific gravity of 2 to 5.

4. The mask of claim 1, wherein the mask frame is made of aluminum or titanium.

5. The mask of claim 1, wherein the connection frame is made of the same material as the mask plate.

6. The mask of claim 5, wherein the connection frame is made of stainless steel or nickel alloy steel.

7. The mask of claim 1, wherein the fastening members each include:
a male thread; and
a female thread formed in the connection frame and the mask frame.

8. A method of manufacturing a mask, the method comprising:
providing a mask frame;
fastening a connection frame to the mask frame using fastening members; and
welding the mask plate to the connection frame.

9. The method of claim 8, wherein the mask frame is made of a metal having a specific gravity of 8 or less.

10. The method of claim 8, wherein the mask frame is made of a metal having a specific gravity of 2 to 5.

11. The method of claim 8, wherein the connection frame is made of the same material as the mask plate.

12. The method of claim 11, wherein the connection frame is made of stainless steel or nickel alloy steel.

13. The method of claim 8, wherein the fastening members each include:
a male thread; and
a female thread formed in the connection frame and the mask frame.
